(19) United States
(12) Patent Application Publication
(10) Pub. No.: US 2025/0353406 A1
(43) Pub. Date: Nov. 20, 2025

(54) VEHICLE SEAT STRUCTURE

(71) Applicant: TOYOTA JIDOSHA KABUSHIKI KAISHA, Toyota-shi (JP)

(72) Inventors: Kohshi KATOH, Hadano-shi (JP); Koki KUNUGI, Fuji-shi (JP); Taiki MORII, Tokyo (JP); Ryosuke TANAHASHI, Mishima-shi (JP); Yasushi DOHNOUE, Seto-shi (JP); Masanori TSUZUKI, Okazaki-shi (JP); Masatoshi HADA, Nisshin-shi (JP)

(73) Assignee: TOYOTA JIDOSHA KABUSHIKI KAISHA, Toyota-shi (JP)

(21) Appl. No.: 19/032,866

(22) Filed: Jan. 21, 2025

(30) Foreign Application Priority Data
May 16, 2024 (JP) 2024-080496

(51) Int. Cl. B60N 2/02; B60N 2/64

(52) U.S. Cl. CPC B60N 2/028; B60N 2/64

(57) ABSTRACT

The vehicle seat structure has a seat back sub-frame linked to the seat back main frame by a plurality of wires so as to limit movement in the seat front-rear direction and to be movable in the roll direction. The wire includes a pair of upper-side support wires on the upper side in the seat up-down direction and on both sides in the seat width direction to connect the seat back main frame and the seat back sub-frame, inclined inward in the seat width direction from the seat rear side toward the seat front side; and a pair of lower-side support wires on the lower side in the seat up-down direction and on both sides in the seat width direction to connect the seat back main frame and the seat back sub-frame, inclined inward in the seat width direction from the seat rear side toward the seat front side.

### CROSS-REFERENCE TO RELATED APPLICATION

This application claims priority to Japanese Patent Application No. 2024-080496 filed on May 16, 2024, incorporated herein by reference in its entirety.

### BACKGROUND

### 1. Technical Field

The present disclosure relates to a vehicle seat structure.

### 2. Description of Related Art

Japanese Unexamined Patent Application Publication No. 2021-112972 (JP 2021-112972 A) discloses a seat device including a main frame that is linked to a seat cushion via a reclining shaft, and a sub-frame that is swingable in a roll direction with respect to the main frame.

### SUMMARY

With the structure described in JP 2021-112972 A, the posture of an occupant can be stabilized by swinging the sub-frame in accordance with an inertial force acting on the occupant when driving. However, there is room for improvement in terms of improving stability of the upper body of the occupant when turning.

The present disclosure provides a vehicle seat structure capable of improving stability of an upper body of an occupant during turning of a vehicle.

A vehicle seat structure according to a first aspect includes:
a seat back main frame that is linked to a seat rearward side end portion of a seat cushion, and
   a seat back sub-frame that is linked by a plurality of wires to the seat back main frame, such that movement in a seat front-rear direction is restricted, and also so as to be movable in a roll direction, in which
   the wires include a pair of upper-side support wires that is disposed on both sides in a seat width direction, on an upper side in a seat up-down direction, and that connects the seat back main frame and the seat back sub-frame in the seat front-rear direction while inclining toward an inner side in the seat width direction from the seat rearward side toward a seat forward side, and a pair of lower-side support wires that is disposed on both sides in the seat width direction, on a lower side in the seat up-down direction, and that connects the seat back main frame and the seat back sub-frame in the seat front-rear direction while inclining toward the inner side in the seat width direction from the seat rearward side toward the seat forward side.

In the vehicle seat structure according to the first aspect, the seat back main frame is linked to the seat rearward side of the seat cushion. Also, the seat back sub-frame is linked to the seat back main frame by the wires. The seat back sub-frame restricts the movement of the seat back main frame in the seat front-rear direction and is also movable in the roll direction. Accordingly, even when an inertial force in a right-left direction is generated with respect to the occupant during traveling of the vehicle, the position of the head of the occupant can be suppressed from moving greatly by the seat back sub-frame swinging in the roll direction.

Also, the wires include the upper-side support wires and the lower-side support wires. The upper-side support wires are each disposed on the seat upper side so as to link the seat back main frame and the seat back sub-frame in the seat front-rear direction, inclining toward the inner side in the seat width direction from the seat rearward side toward the seat forward side. Further, the lower-side support wires are each disposed on the seat lower side so as to link the seat back main frame and the seat back sub-frame in the seat front-rear direction, inclining toward the inner side in the seat width direction from the seat rearward side toward the seat forward side. Accordingly, a straight line passing through an intersection point of lines extending from the upper-side support wires and an intersection point of lines extending from the lower-side support wires serves as an imaginary yaw axis of the seat back sub-frame. The seat back sub-frame swings about this yaw axis. Thus, the upper body of the occupant can be directed toward an inward side of turning, as compared with a configuration in which the upper-side support wires and the lower-side support wires extend substantially in parallel.

In the vehicle seat structure according to the first aspect, a straight line connecting an upper-side intersection point at which imaginary lines extending from the upper-side support wires toward the seat forward side intersect and a lower-side intersection point at which imaginary lines extending from the lower-side support wires toward the seat forward side intersect passes through a steering wheel.

In the vehicle seat structure according to the above aspect, the straight line connecting the upper-side intersection point and the lower-side intersection point is situated at a position of passing through the steering wheel. Accordingly, the seat back sub-frame can be swung about an axis near the steering wheel with respect to a driver gripping the steering wheel.

In the vehicle seat structure according to the first aspect, the straight line extends vertically.

In the vehicle seat structure according to the above aspect, the seat back sub-frame can be swung about the virtual yaw axis that extends vertically.

In the vehicle seat structure according to the first aspect, a lower-side intersection point at which imaginary lines extending from the lower-side support wires toward the seat forward side intersect is situated on the seat forward side and also a seat upward side with respect to an upper-side intersection point at which imaginary lines extending from the upper-side support wires toward the seat forward side intersect.

In the vehicle seat structure according to the above aspect, the straight line connecting the upper-side intersection point and the lower-side intersection point is inclined upward from the seat rearward side toward the seat forward side. Thus, the seat back sub-frame can be swung about this yaw axis with the inclined straight line as a virtual yaw axis.

In the vehicle seat structure according to the first aspect, a straight line connecting the lower-side intersection point and the upper-side intersection point is situated on the seat rearward side from the steering wheel.

In the vehicle seat structure according to the above aspect, the seat back sub-frame can be swung about the axis on the seat rearward side of the steering wheel. Accordingly, the upper body of the occupant is more easily directed toward the inward side of turning.

As described above, according to the vehicle seat structure of the present disclosure, stability of the upper body of the occupant can be improved when the vehicle turns.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a main part of a vehicle seat to which a vehicle seat structure according to an embodiment is applied;

FIG. 2 is an exploded perspective view illustrating a seat back main frame according to the embodiment;

FIG. 3 is an exploded perspective view illustrating a seat back sub-frame according to the embodiment;

FIG. 4 is a perspective view showing an assembled seat back sub-frame in the embodiment;

FIG. 5 is a perspective view illustrating an extending direction of the upper-side support wire and the lower-side support wire in the embodiment;

FIG. 6 is a perspective view illustrating an extending direction of the upper-side support wire and the lower-side support wire in a modification;

FIG. 7A is a time chart of a steering angle;

FIG. 7B is a time chart of the right-left velocity of the chest; and

FIG. 7C is a time chart of angular velocity of the chest about a yaw axis.

### DETAILED DESCRIPTION OF EMBODIMENTS

A vehicle seat structure according to an embodiment will be described with reference to the drawings.

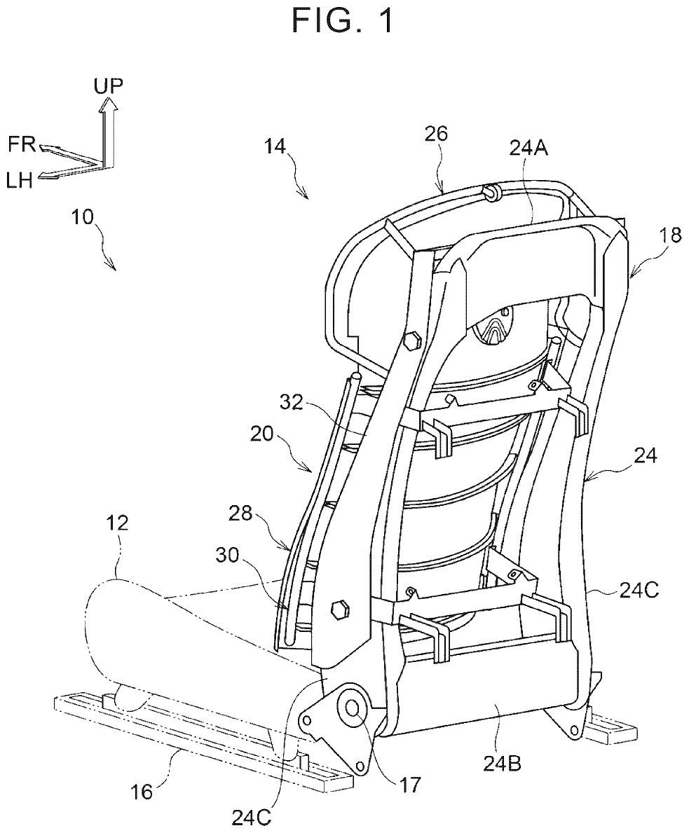

FIG. 1 is a perspective view showing a main part of a vehicle seat 10 to which a vehicle seat structure according to an embodiment is applied. Note that the arrow FR, the arrow UP, and the arrow LH in the drawing indicate the seat front direction, the seat upper direction, and the seat left direction of the vehicle seat 10, respectively. In the following description, when the front, rear, up, down, and left and right directions are used without any specific mention, the front and rear directions in the front-rear direction of the seat, the up and down directions in the up-down direction of the seat, and the left and right of the seat width direction are respectively indicated.

As shown in FIG. 1, the vehicle seat 10 of the present embodiment includes a seat cushion 12 and a seat back 14. The seat cushion 12 extends in the seat front-rear direction and the seat width direction, and is configured to support the buttocks and thighs of the occupant from below. Further, the seat cushion 12 is fixed to a floor panel (not shown) via the seat rail 16, and is configured to be movable in the front-rear direction via the seat rail 16.

A rear end portion of the seat cushion 12 is linked to the seat back 14. The seat back 14 extends in the seat width direction and the seat up-down direction, and is configured to support the back of the occupant from the rear.

seat back 14 includes a seat back main frame 18 and a seat back sub-frame 20. The seat back main frame 18 is rotatably linked to an end portion of the seat cushion 12 on the seat rear side via a support shaft 17. The seat back main frame 18 also includes a frame main body 24 and a wire relay member 26. The seat back sub-frame 20 includes a support plate 28 and a support plate mounting member 30.

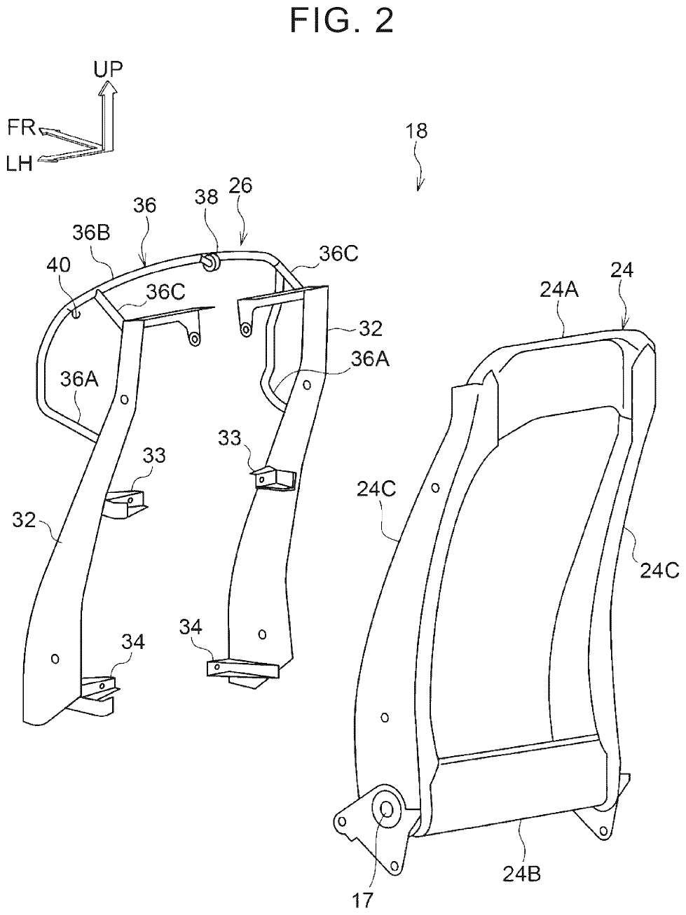

FIG. 2 is an exploded perspective view illustrating the seat back main frame 18 according to the embodiment. As shown in FIG. 2, the frame main body 24 constituting the seat back main frame 18 is formed in a substantially rectangular frame shape including an upper frame 24A, a lower frame 24B, and a pair of left and right side frames 24C.

The upper frame 24A is disposed on the upper portion of the frame main body 24 and extends in the seat width-direction. The lower frame 24B is disposed at a lower portion of the frame main body 24 and extends in the seat width-direction, and the support shaft 17 is inserted therethrough. Each of the pair of left and right side frames 24C extends in the seat up-down direction, and links the right end portions of the upper frame 24A and the lower frame 24B to the left end portions of the upper frame 24A and the lower frame 24B.

The wire relay member 26 includes a pair of left and right side plates 32 and a relay pipe 36. Each of the pair of left and right side plates 32 is fixed to the outer side of the side frames 24C of the frame main body 24 by bolts or the like. In addition, an upper side front bracket 33 protrudes inward in the seat width direction at a center portion of the side plate 32 in the up-down direction, and a lower side front bracket 34 protrudes inward in the seat width direction at a lower end portion of the side plate 32.

The relay pipe 36 is provided at an upper portion of the side plate 32, and is a pipe-shaped member extending from the side plate 32 toward the seat front side. The relay pipe 36 includes a front-rear extending portion 36A extending from a slightly upper portion to a seat front side from a seat up-down direction central portion of the pair of left and right side plates 32. Further, the relay pipe 36 includes a substantially arcuate arch portion 36B linking the front end portion of the front-rear extending portion 36A, and a linking portion 36C linking the arch portion 36B and the upper end portion of the side plate 32 back and forth.

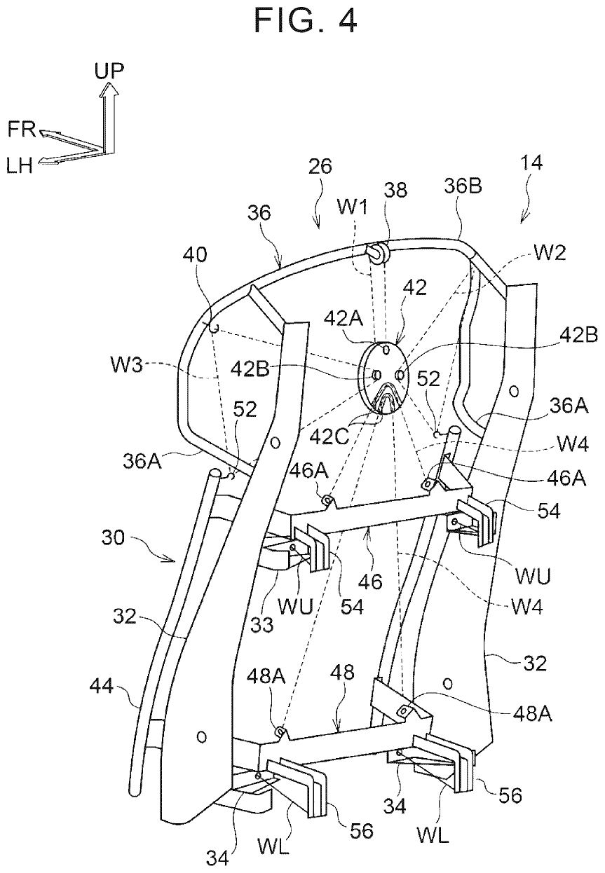

Here, a pulley 38 is provided at a center portion in the seat width direction in the arch portion 36B of the relay pipe 36, and hooks 40 are provided at both end portions in the seat width direction in the arch portion 36B. In FIG. 2, only the hook 40 on the left side of the seat is illustrated, and the hook on the right side of the seat is hidden. The pulley 38 and the hook 40 are configured such that an upper wire W1, a right wire W2, and a left wire W3, which will be described later, are bridged (see FIG. 4).

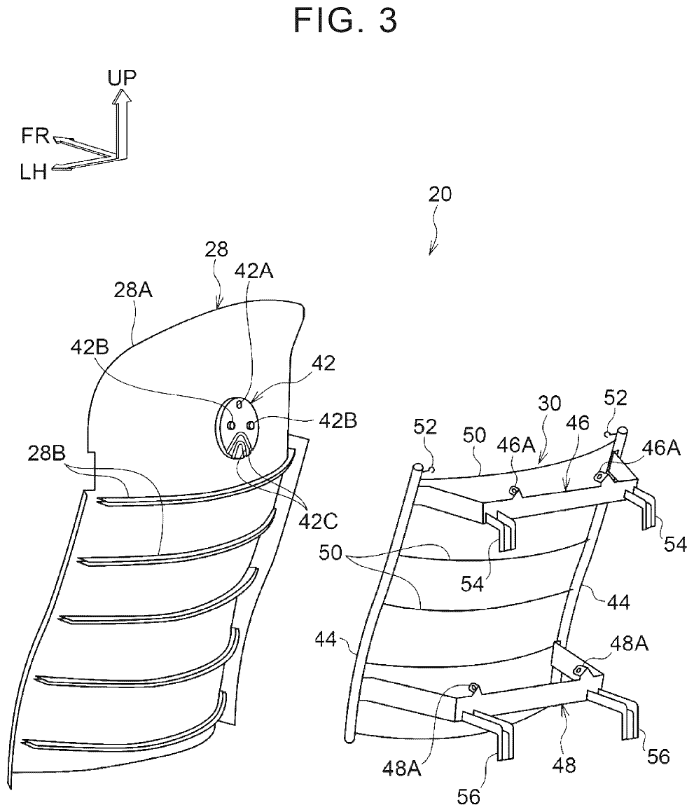

FIG. 3 is an exploded perspective view illustrating the seat back sub-frame 20 according to the embodiment. As shown in FIG. 3, the support plate 28 constituting the seat back sub-frame 20 includes a base plate 28A that is plate-shaped and capable of supporting the back of the occupant, and both seat-width-direction end portions of the base plate 28A are curved toward the seat rear side. Further, a plurality of wire guides 28B are provided on the back surface of the base plate 28A, and in the present embodiment, five wire guides 28B are provided in up-down direction. Each of the wire guides 28B extends in the seat width direction, and is formed so as to be capable of inserting the lateral wire 50 of the support plate mounting member 30.

A disc member 42 is provided on the rear surface of the upper portion of the base plate 28A. The disc member 42 is formed in a substantially disk shape, and a through-hole 42A is formed in an upper portion of the disc member 42. A pair of left and right protruding portions 42B are formed on the disc member 42. Further, two substantially V-shaped groove portions 42C which are upside down are formed in the lower portion of the disc member 42. As shown in FIG. 4, the disc member 42 has a function of relaying the upper wire W1, the right wire W2, the left wire W3, and the lower wire W4. The upper wire W1, the right wire W2, the left wire W3, and the lower wire W4 will be described later.

As shown in FIG. 3, the support plate mounting member 30 includes a pair of left and right shaft portions 44, and an upper linking portion 46 and a lower linking portion 48 that are provided between the shaft portions 44. Each of the shaft portions 44 extends in the seat up-down direction and is disposed at both end portions of the support plate 28 in the seat width direction. Further, a plurality of lateral wires 50 are stretched between the left and right shaft portions 44, and in the present embodiment, five lateral wires 50 are stretched vertically. Each of the five lateral wires 50 is inserted into the wire guides 28B to support the base plate 28A by the lateral wires 50. Further, a hook 52 is provided at an upper end portion of the shaft portion 44.

The upper linking portion 46 is formed in a substantially U-shape with the front side of the seat opened in plan view, and both end portions of the upper linking portion 46 are fixed to the shaft portion 44. Further, a pair of left and right upper protruding pieces 46A protrude from the seat-width-direction-extending part of the upper linking portion 46 toward the seat front side. Further, the upper-side rear brackets 54 protrude from the seat-width-direction outer side toward the seat rear side relative to the upper protruding piece 46A. The upper-side rear bracket 54 extends from the upper linking portion 46 toward the seat rear side and is further bent toward the seat lower side, so that it is formed in a substantially L-shape when viewed in the seat width direction.

The lower linking portion 48 is disposed below the upper linking portion 46, and is formed in a substantially U-shape with the front side of the seat open in plan view. Both end portions of the lower linking portion 48 are fixed to the shaft portion 44. Further, a pair of left and right lower protruding pieces 48A are provided to protrude from a part of the lower linking portion 48 extending in the seat width-direction toward the seat front side. Further, the lower-side rear brackets 56 protrude from the seat width-direction outer side toward the seat rear side from the lower protruding piece 48A. The lower-side rear bracket 56 extends from the lower linking portion 48 toward the seat rear side and is further bent toward the seat lower side, and thus is formed in a substantially L-shape when viewed from the seat width direction.

FIG. 4 is a perspective view illustrating a state in which the seat back sub-frame 20 according to the embodiment is assembled. Note that in FIG. 4, a part of the illustration is omitted for convenience of explanation. As shown in FIG. 4, the upper wire W1 is stretched between the disc member 42 and the pulley 38 of the relay pipe 36. Specifically, a lower portion of the upper wire W1 is passed through the through-hole 42A of the disc member 42, and an upper portion of the upper wire W1 is wound around the pulley 38.

The right wire W2 is bridged between the right protruding portion 42B of the disc member 42, the hook 40 of the relay pipe 36, and the hook 52 of the shaft portion 44. Therefore, the right-wire W2 is stretched in a substantially triangular shape having the protruding portion 42B, the hook 40, and the hook 52 as vertices when viewed from the front-rear direction of the seat.

The left wire W3 is bridged between the left protruding portion 42B of the disc member 42, the hook 40 of the relay pipe 36, and the hook 52 of the shaft portion 44. Therefore, the left wire W3 is stretched in a substantially triangular shape having the protruding portion 42B, the hook 40, and the hook 52 as vertices when viewed from the front-rear direction of the seat.

Two lower wire W4 are provided, the upper lower wire W4, relaying the groove portion 42C on the upper side, one end portion is fixed to the upper protruding piece 46A on the right, the other end portion is fixed to the upper protruding piece 46A on the left. Further, in the lower wire W4, one end portion is fixed to the right lower protruding piece 48A and the other end portion is fixed to the left lower protruding piece 48A by relaying the groove portion 42C on the lower side. As described above, the seat back sub-frame 20 is suspended from the seat back main frame 18 by the upper wire W1, the right wire W2, the left wire W3, and the lower wire W4. Therefore, the seat back sub-frame 20 is movable relative to the seat back main frame 18.

Here, the seat back sub-frame 20 is configured such that the seat front-rear direction motion is limited by the upper-side support wire WU and the lower-side support wire WL. Specifically, the upper-side support wire WU connects the pair of left and right upper side front brackets 33 and the pair of left and right upper-side rear brackets 54 in the seat front-rear direction. A front end of the upper-side support wire WU is fixed to the upper side front bracket 33, and a rear end of the upper-side support wire WU is fixed to the upper-side rear bracket 54.

The lower-side support wire WL connects the pair of left and right lower side front brackets 34 and the pair of left and right lower-side rear brackets 56 in the seat front-rear direction. A front end of the lower-side support wire WL is fixed to the lower side front bracket 34, and a rear end of the lower-side support wire WL is fixed to the lower-side rear bracket 56. As described above, the seat back sub-frame 20 is linked to the seat back main frame 18 so as to limit movement in the seat front-rear direction and to be movable in the roll direction.

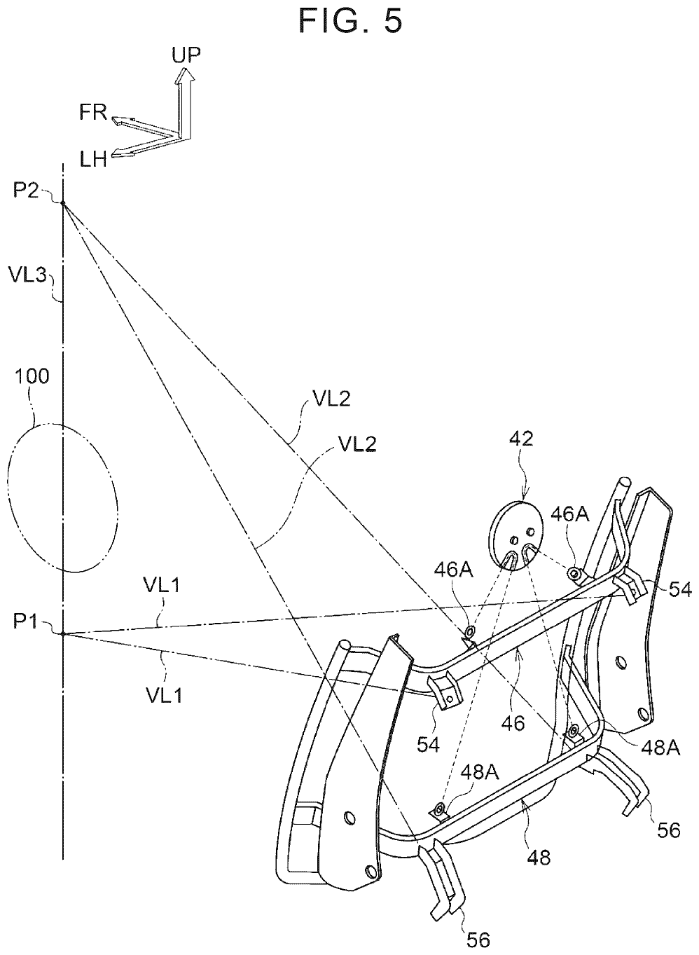

FIG. 5 is a perspective view illustrating an extension of the upper-side support wire WU and the lower-side support wire WL in the embodiment. In FIG. 5, the imaginary line in which the upper-side support wire WU is extended is shown by VL1, and the imaginary line in which the lower-side support wire WL is extended is shown by VL2.

As shown in FIG. 5, the upper-side support wire WU and the lower-side support wire WL are inclined inward in the seat widthwise direction from the seat rear side toward the seat front side. Further, the upper-side support wire WU is inclined toward the seat lower side from the seat rear side toward the seat front side, and the lower-side support wire WL is inclined toward the seat upper side from the seat rear side toward the seat front side. Therefore, when viewed from the seat width direction, the imaginary line VL1 in which the upper-side support wire WU extends toward the seat front side intersects with the imaginary line VL2 in which the lower-side support wire WL extends toward the seat front side.

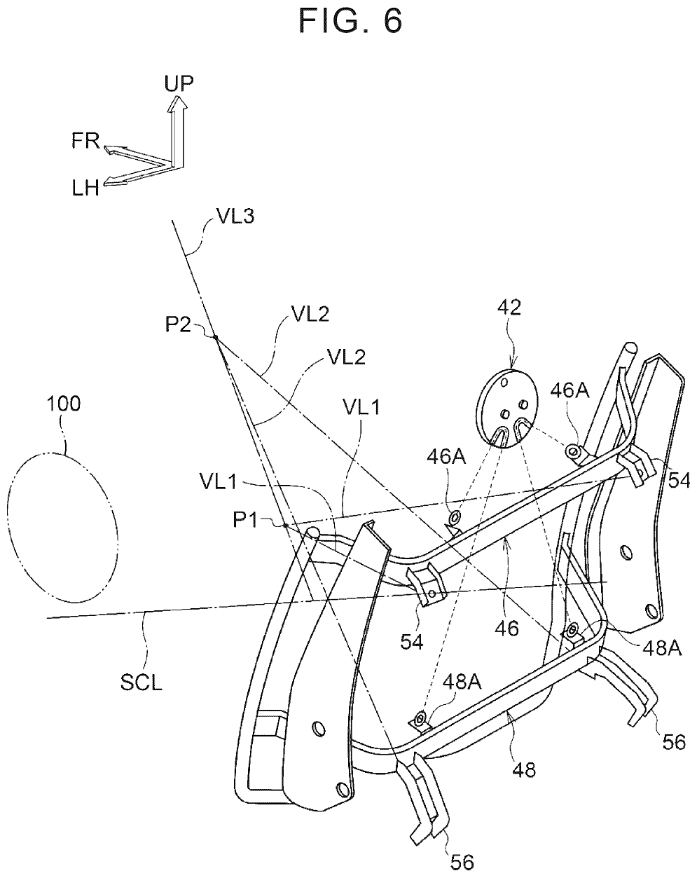

Further, a straight line VL3 connecting the upper-side intersection point P1, which is the intersection point of the pair of imaginary lines VL1, and the lower-side intersection point P2, which is the intersection point of the pair of imaginary lines VL2, passes through the steering wheel 100. In the present embodiment, since the upper-side intersection point P1 and the lower-side intersection point P2 coincide with each other in the seat front-rear direction and the seat width direction, the straight line VL3 extends perpendicularly. Then, the straight line VL3 becomes a virtual yaw-axis of the seat back sub-frame 20. However, the present disclosure is not limited thereto, and a configuration in which the upper-side intersection point P1 and the lower-side intersection point P2 are shifted in the seat front-rear direction may be employed. The configuration of this modification will be described with reference to FIG. 6.

### Modifications

FIG. 6 is a perspective view illustrating an extending direction of the upper-side support wire and the lower-side support wire according to the modification. As shown in FIG. 6, in the present modification, the upper-side support wire WU and the lower-side support wire WL are inclined inward in the seat widthwise direction from the seat rear side toward the seat front side as in the embodiment. Further, the upper-side support wire WU is inclined toward the seat lower side from the seat rear side toward the seat front side, and the lower-side support wire WL is inclined toward the seat upper side from the seat rear side toward the seat front side. Therefore, when viewed from the seat width direction, the imaginary line VL1 in which the upper-side support wire WU extends toward the seat front side intersects with the imaginary line VL2 in which the lower-side support wire WL extends toward the seat front side.

Here, in the present modification, the lower-side intersection point P2, which is the intersection point of the pair of imaginary lines VL2, is located on the seat front side and the seat upper side with respect to the upper-side intersection point P1, which is the intersection point of the pair of imaginary lines VL1. A straight line VL3 connecting the lower-side intersection point P2 and the upper-side intersection point P1 is located on the seat rear side of the steering wheel 100.

As described above, in the present modification, the straight line VL3 is inclined toward the seat upper side from the seat rear side toward the seat front side, and this straight line VL3 becomes a virtual yaw-axis of the seat back sub-frame 20.

### Operations

Next, the operation of the vehicle seat structure according to the present embodiment and the modification will be described.

In the vehicle seat structure according to the present embodiment and the modification example, as shown in FIG. 1, the seat back main frame 18 is linked to the seat rear side of the seat cushion 12. Further, as shown in FIG. 4, the seat back sub-frame 20 is linked to the seat back main frame 18 by a plurality of wires. The seat back sub-frame 20 restricts movement in the seat front-rear direction with respect to the seat back main frame 18 and is movable in the roll direction. Accordingly, even when an inertial force in the right-left direction is generated with respect to the occupant during traveling of the vehicle, the seat back sub-frame 20 swings in the roll direction, so that it is possible to prevent the position of the head of the occupant from moving greatly.

In addition, the vehicle seat structure according to the present embodiment includes a pair of upper-side support wire WU and a pair of lower-side support wire WL. Each of the pair of upper-side support wire WU is disposed on the seat upper side and connects the seat back main frame 18 and the seat back sub-frame 20 in the seat front-rear direction. Each of the pair of upper-side support wire WU is inclined inward in the seat width-direction from the seat rear side toward the seat front side. Each of the pair of lower-side support wire WL is disposed on the seat lower side to connect the seat back main frame 18 and the seat back sub-frame 20 to each other in the seat front-rear direction. Each of the pair of lower-side support wire WL is inclined inward in the seat width-direction from the seat rear side toward the seat front side. Thus, as shown in FIG. 5, a straight line VL3 passing through the upper-side intersection point P1 on the extension line of the pair of upper-side support wires WU and the lower-side intersection point P2 on the extension line of the pair of lower-side support wires WL becomes a virtual yaw axis of the seat back sub-frame 20. The seat back sub-frame 20 is swing about this yaw axis. As a result, compared to a configuration in which the upper-side support wire and the lower-side support wire extend substantially in parallel, the upper body of the occupant can be directed toward the turning inside, and the stability of the upper body of the occupant can be improved when the vehicle turns.

In particular, in the present embodiment, a straight line VL3 connecting the upper-side intersection point P1 and the lower-side intersection point P2 is located at a position passing through the steering wheel 100. Therefore, the seat back sub-frame 20 can be swung around the axis near the steering wheel 100 with respect to the driver holding the steering wheel 100. In addition, the seat back sub-frame 20 can be swung around a virtual yaw axis extending vertically.

On the other hand, in the configuration of the modification, as shown in FIG. 6, the straight line VL3 connecting the upper-side intersection point P1 and the lower-side intersection point P2 inclines upward from the seat rear side toward the seat front side. As a result, the seat back sub-frame 20 can be swung around the yaw axis using the straight line VL3 that is inclined as a virtual yaw axis.

Further, in the structure of the modified example, the seat back sub-frame 20 can be swung around the seat rear side axis relative to the steering wheel 100. Therefore, the upper body of the occupant is more easily directed toward the turning inner side.

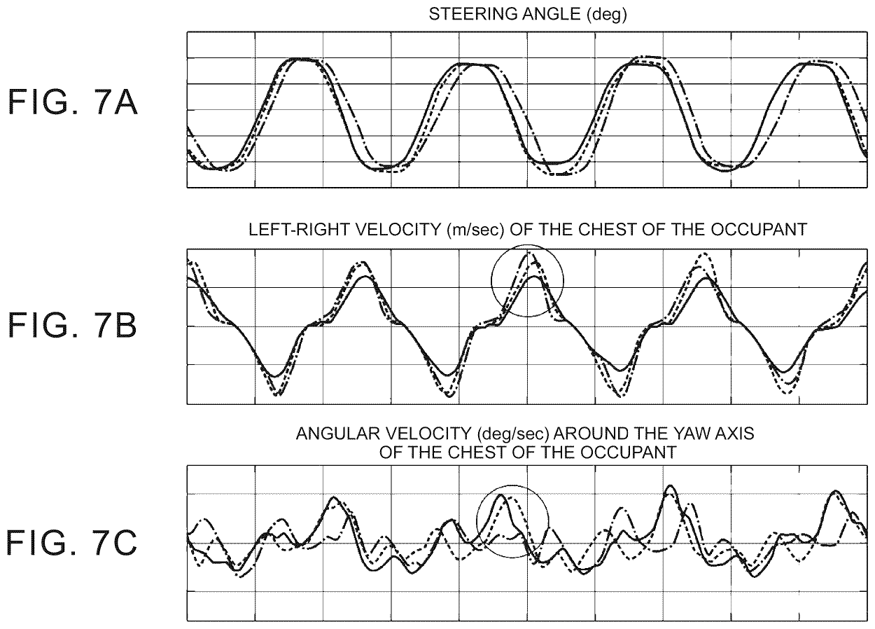

Benefits of the present embodiment and modifications will be described with reference to the graphs shown in FIGS. 7A to 7C. FIGS. 7A to 7C show the results of measuring the lateral velocity of the chest and the angular velocity around the yaw axis of the occupant seated in the seat of the vehicle when the lateral gravitational acceleration is simulated to be 0.2G. The vehicle seat is installed on a trapezoidal test apparatus capable of six-axis vibration, and the test apparatus is vibrated by a predetermined program to reproduce the slow travel.

In FIGS. 7A to 7C, the measurement results in the vehicle seat to which the vehicle seat structure of the comparative example is applied are indicated by dashed-dotted lines, and the measurement results in the vehicle seat to which the vehicle seat structure of the embodiment is applied are indicated by dashed lines. In addition, a measurement result in the vehicle seat to which the vehicle seat structure of the modification example is applied is indicated by a solid line. The vehicle seat of the comparative example has the same configuration as the embodiment except for the upper-side support wire and the lower-side support wire, and the pair of upper-side support wires extend substantially in parallel. A pair of lower-side support wires also extend substantially parallel. Therefore, in the comparative example, the pair of upper-side support wires do not intersect with each other, and the pair of lower-side support wires do not intersect with each other.

In FIG. 7A, the steering angle is shown for each elapsed time. In FIG. 7B, the left and right velocities of the chest of the occupant at the same time are shown. In FIG. 7C, the angular velocity around the yaw-axis of the chest of the occupant at the same time is shown. As can be seen from FIG. 7A, the steering angle is periodically changed with the elapse of the elapsed period because the slalom travel is simulated.

In FIG. 7C, the vehicle seat structure of the embodiment and the vehicle seat structure of the modification example show that the angular velocity around the yaw axis of the chest of the occupant is larger than that of the vehicle seat structure of the comparative example. From the results, it can be seen that, in the vehicle seat structure of the embodiment and the vehicle seat structure of the modification example, the chest of the occupant rotates about the yaw axis during the traveling of the slalom. In addition, it was confirmed that the occupant was pointing toward the inside of the turn during the traveling of the slalom. Therefore, in the vehicle seat structure of the embodiment and the vehicle seat structure of the modification example, the upper body of the occupant can be directed toward the turning inside with respect to the structure of the comparative example in which the upper-side support wire and the lower-side support wire extend substantially in parallel. As a result, the vehicle seat structure of the embodiment and the vehicle seat structure of the modification can improve the stability of the upper body of the occupant when the vehicle turns.

In addition, in FIG. 7B, when a part surrounded by a circle is viewed, the left-right velocity of the chest of the occupant during the traveling of the slalom is smaller in the vehicle seat structure of the modification than in the vehicle seat structure of the embodiment. As a result, it can be seen that, with respect to the vehicle seat structure of the embodiment, in the vehicle seat structure of the modified example, the movement of the left-right movement of the chest is converted into the rotational movement. Therefore, in the vehicle seat structure of the modification example, it can be confirmed that the occupant is more easily directed toward the turning inner side than the vehicle seat structure of the embodiment.

Although the vehicle seat structure according to the embodiment and the modification has been described above, it is needless to say that the vehicle seat structure can be implemented in various forms without departing from the gist of the present disclosure. For example, in the above-described embodiments and modifications, the seat surface of the seat cushion 12 may be configured to be swingable. As a structure in which the seat surface of the seat cushion is swingable, for example, the structure disclosed in Japanese Unexamined Patent Application Publication No. 2021-24473 (JP 2021-24473 A) can be used. In this case, by setting the straight line VL3 connecting the lower-side intersection point P2 and the upper-side intersection point P1 of the vehicle seat structure according to the modification shown in FIG. 6 to be perpendicular to the seat surface swing axis, the attitude of the occupant at the time of turning of the vehicle can be stabilized most.

In the above-described embodiment, as shown in FIG. 5, the imaginary line VL1 in which the upper-side support wire WU is extended toward the seat front side and the imaginary line VL2 in which the lower-side support wire WL is extended toward the seat front side intersect each other, but the present disclosure is not limited thereto. For example, the imaginary line VL1 and the imaginary line VL2 may not intersect each other, and the upper-side intersection point P1 may be disposed above the lower-side intersection point P2.

With respect to the above embodiments, the following supplementary notes are disclosed.

### Appendix 1

A vehicle seat structure comprising:
A seat back main frame linked to the seat rear end portion of the seat cushion;
By a plurality of wires, a seat back sub-frame which is movably linked to restrict the movement of the seat back main frame in the seat front-rear direction and in the roll direction,
wherein:

The wire includes a pair of upper-side support wires disposed on both sides in the seat up-down direction and in the seat width direction and inclined inward in the seat width direction from the seat rear side toward the seat front side together with connecting the seat back main frame and the seat back sub-frame in the seat front-rear direction, and a pair of lower-side support wires disposed on both sides in the seat up-down direction and in the seat width direction and inclined inward in the seat width direction from the seat rear side toward the seat front side together with connecting the seat back main frame and the seat back sub-frame in the seat front-rear direction.

### Appendix 2

### Vehicle Seat Structure According to Appendix 1

A straight line connecting an upper-side intersection point at which an imaginary line extending the pair of upper-side support wires toward the front side of the seat intersects and a lower-side intersection point at which an imaginary line extending the pair of lower-side support wires toward the front side of the seat intersects passes through the steering wheel.

### Appendix 3

### Vehicle Seat Structure According to Appendix 2

The straight line extends vertically.

### Appendix 4

### Vehicle Seat Structure According to Appendix 1 or 2

A lower-side intersection point at which an imaginary line extending from the pair of lower-side support wires toward the front side of the seat intersects is positioned on the front side of the seat and the upper side of the seat with respect to an upper-side intersection point at which an imaginary line extending from the pair of upper-side support wires toward the front side of the seat intersects.

### Appendix 5

### Vehicle Seat Structure According to Appendix 4

A straight line connecting the lower-side intersection point and the upper-side intersection point is located on the seat rear side of the steering wheel.

What is claimed is:

1. A vehicle seat structure comprising:
a seat back main frame that is linked to an end portion of a seat cushion at a seat rearward side; and
a seat back sub-frame that is linked by a plurality of wires to the seat back main frame, such that movement in a seat front-rear direction is restricted, and also so as to be movable in a roll direction, wherein the wires include a pair of upper-side support wires that is disposed on both sides in a seat width direction, on an upper side in a seat up-down direction, and that connects the seat back main frame and the seat back sub-frame in the seat front-rear direction while inclining toward an inner side in the seat width direction from the seat rearward side toward a seat forward side, and a pair of lower-side support wires that is disposed on both sides in the seat width direction, on a lower side in the seat up-down direction, and that connects the seat back main frame and the seat back sub-frame in the seat front-rear direction while inclining toward the inner side in the seat width direction from the seat rearward side toward the seat forward side.

2. The vehicle seat structure according to claim 1, wherein a straight line connecting an upper-side intersection point at which imaginary lines extending from the upper-side support wires toward the seat forward side intersect and a lower-side intersection point at which imaginary lines extending from the lower-side support wires toward the seat forward side intersect passes through a steering wheel.

3. The vehicle seat structure according to claim 2, wherein the straight line extends vertically.

4. The vehicle seat structure according to claim 1, wherein a lower-side intersection point at which imaginary lines extending from the lower-side support wires toward the seat forward side intersect is situated on the seat forward side and also a seat upward side with respect to an upper-side intersection point at which imaginary lines extending from the upper-side support wires toward the seat forward side intersect.

5. The vehicle seat structure according to claim 4, wherein a straight line connecting the lower-side intersection point and the upper-side intersection point is situated on the seat rearward side from a steering wheel.
